(19) United States
(12) Patent Application Publication
(10) Pub. No.: US 2011/0043641 A1
(43) Pub. Date: Feb. 24, 2011

(54) CONFIGURING A DIGITAL CAMERA AS A CO-PROCESSOR

(76) Inventors: John Louis Warpakowski Furlan, Belmont, CA (US); Jonathan Kaplan, San Francisco, CA (US); Michael Denis O'Connor, Cary, NC (US); Mark Kalman, San Francisco, CA (US); Edward Vernon Bacho, Sunnyvale, CA (US); Shane D. Looker, Union City, CA (US)

Correspondence Address: PATTERSON & SHERIDAN, LLP/CISC, 3040 POST OAK BLVD., SUITE 1500, HOUSTON, TX, 77056-6582, US

(21) Appl. No.: 12/544,874

(22) Filed: Aug. 20, 2009

(51) Int. Cl. H04N 5/225

(52) U.S. Cl. 348/207.1; 348/E05.024

(57) ABSTRACT

A processor included in a digital camera operates as a co-processor in conjunction with a processor included in a computing device to perform one or more processing operations involving digital video, audio, and/or still images. When the digital camera is coupled to the computing device, the processor in the computing device causes the processor in the digital camera to perform one or more processing operations involving the digital video, audio and/or still images. Advantageously, a user of the digital camera is not limited by the processing resources of the computing device when performing processing operations involving the digital video, audio, and/or still images.

### BACKGROUND OF THE INVENTION

1. Field of the Invention

The invention relates generally to digital cameras and, more specifically, to a configuring a digital camera as a co-processor.

2. Description of the Related Art

Using known techniques, software applications may be configured to perform various processing operations on digital video, audio, and/or still images using the processor included within a personal computer (PC). These processing operations may include transcoding operations, frame size modification operations, frame rate modification operations, bit rate modification operations, compression operations, decompression operations, resolution modification operations, or stitching operations, among others. A user may initiate one or more of these processing operations to convert the video, audio, and/or still images into a particular format suitable for playing back the video, audio, and/or still images using a device other than the digital camera on which the digital video, audio, and/or still images were captured. For example, the end-user could use the software application to cause the digital video to be converted into a format that can be played back by a video player application executing on the PC. Alternatively, the user could use the software application to cause the digital video to be converted into a format that is supported by a video-hosting website. The user could then upload the converted digital video to the video-hosting website for viewing online.

However, some PCs lack the processing resources required to perform the processing operations effectively. For example, if the software program attempts to process digital video, audio, and/or still images, then the software application may consume a significant amount of the processing resources available on the PC, causing the PC to slow down, stall, or crash. If the user does not have access to a PC with the required processing resources, then the user cannot effectively implement the processing operations using the software application. Thus, the user may not be able to access the digital video, audio, and/or still images using a device other than the digital camera, thereby limiting the portability of the video, audio, and/or still images.

As the foregoing illustrates, what is needed in the art is a more effective technique for processing digital content.

### SUMMARY

One embodiment of the invention is a computer-implemented method for performing one or more processing operations involving a digital camera in data communication with a computing device. The method includes the steps of determining that audio/video data is stored in a memory included within the digital camera, determining at least one processing operation that can be performed on the audio/video data by a processor included in the digital camera, and causing the processor included in the digital camera to generate processed audio/video data by performing the at least one processing operation on at least a portion of the audio/video data.

Other embodiments of the invention include a computer-readable medium including instructions that, when executed by a processor, cause the processor to perform the functions associated with the computer-implemented method set forth above as well as a system configured to perform the functions associated with the computer-implemented method set forth above.

Advantageously, processor resource requirements across the system are relaxed since all or part of the processing operations that would otherwise be performed by a processor included in a computing device can be offloaded onto a processor included in the digital camera. The end-user is, thus, not limited by the processing limitations of the computing device when performing processing operations involving audio/video data. Consequently, greater processing efficiency is achieved and portability of the audio/video data is increased.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a conceptual diagram that illustrates a computer system configured to implement one or more aspects of the invention;

FIGS. 2A-2B are conceptual diagrams that illustrate the digital camera and the computing device of FIG. 1 in greater detail, according to various embodiments of the invention;

FIG. 3 is a flowchart of method steps for causing a processor residing within a digital camera to perform at least one processing operation on audio/video data stored within the digital camera, according to one embodiment of the invention; and

FIG. 4 is a flowchart of method steps for causing a processor residing within a digital camera to generate processed audio/video data either separately or in conjunction with a processor residing within a computing device, according to one embodiment of the invention.

### DESCRIPTION OF EXAMPLE EMBODIMENTS

In the following description, numerous specific details are set forth to provide a more thorough understanding of the invention. However, it will be apparent to one of skill in the art that the invention may be practiced without one or more of these specific details. In other instances, well-known features have not been described in order to avoid obscuring the invention.

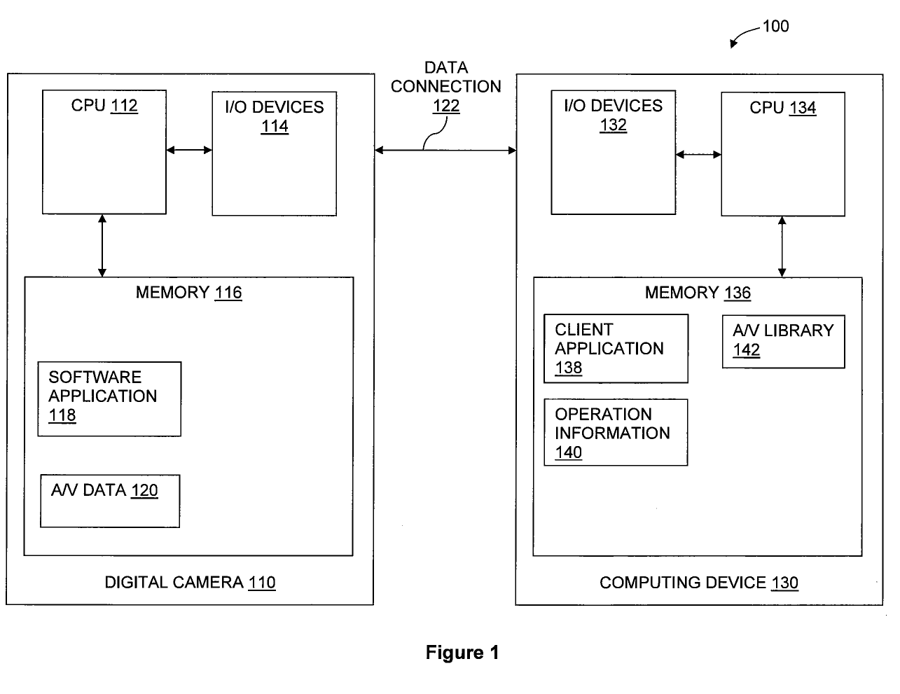

FIG. 1 is a conceptual diagram that illustrates a computer system 100 configured to implement one or more aspects of the invention. As shown, the computer system 100 includes a digital camera 110 and a computing device 130. The digital camera 110 may be a hand-held electronic device configured to capture audio/video (A/V) data, such as digital audio, video, and/or still images. The computing device may be any technically feasible type of computing device, such as a desktop computer, a laptop computer, a personal digital assistant (PDA), a cell phone, or a hand-held electronic device, among others. The digital camera 110 is coupled to the computing device 130 via the data connection 122.

The data connection 122 may be any type of data connection that allows data to be transferred between the digital camera 110 and the computing device 130. For example, the data connection 122 could be a universal serial bus (USB) data connection, a firewire data connection, an Ethernet data connection, a phone data connection, or a wireless network data connection, among others. In one embodiment, the data connection 122 allows an electrical current to be transferred from the computing device 130 to the digital camera 110. The electrical current may be used to provide power to the digital camera 110 and/or to charge batteries associated with the digital camera 110.

As also shown, the digital camera 110 includes a central processing unit (CPU) 112, input/output (I/O) devices 114, and a memory 116. The CPU 112 is coupled to the I/O devices 114 and to the memory 116. The CPU 112 is the primary processor of the digital camera 110 and is configured to coordinate the operations of the digital camera 110, including the capture and/or processing of A/V data, among other operations. The CPU 112 may execute one or more sets of program instructions included in the memory 116, including a driver that, when executed by the CPU 112, controls the operation of various components of the digital camera 110. The one or more software programs and the driver may be stored in the memory 116.

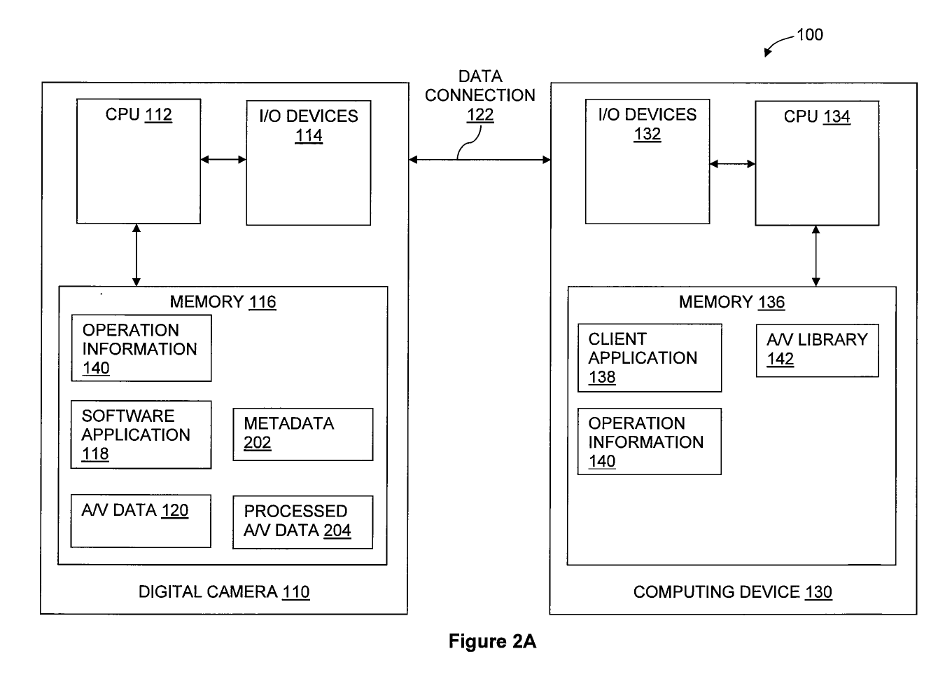

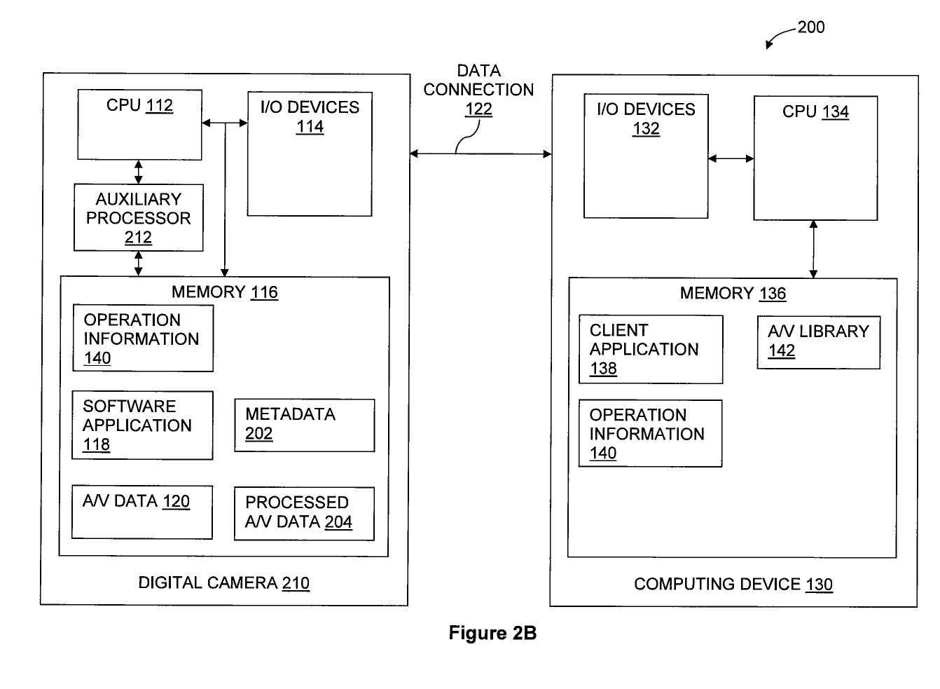

The memory 116 may be a random-access memory (RAM) unit, a dynamic RAM (DRAM) unit, a flash memory module, or any other type of memory unit. The memory 116 includes a software application 118 and A/V data 120. The A/V data 120 includes digital video, audio, and/or still images captured using the digital camera 110 or received by the digital camera 110 via the data connection 122. The software application 118 is a set of program instructions associated with a particular instruction set architecture (ISA) that can be executed by the CPU 112 to perform a variety of processing operations involving the A/V data 120, including transcoding operations, frame size modification operations, frame rate modification operations, bit rate modification operations, compression operations, decompression operations, resolution modification operations, stitching operations, scaling operations, filtering operations, image cleanup operations, video stabilization operations, or formatting operations, among others. In one embodiment, the software application 118 is executed by the CPU 112. In an alternative embodiment, the software application 118 may be executed by an auxiliary processing unit, as described in greater detail in FIG. 2B.

The I/O devices 114 included in the digital camera 110 include input devices configured to capture and/or receive data. For example, the I/O devices 114 may include an optical lens, optical components, a microphone, one or more mechanical buttons, one or more capacitive-touch (CT) buttons, a switch, a touchscreen, or a universal serial bus (USB) port, among others. The I/O devices 114 may also include output devices that can be used to output and/or transmit data. For example, the I/O devices 114 could include a display screen, a backlight, one or more light-emitting diodes (LEDs), or a speaker, among others. When the I/O devices 114 include a display screen and a speaker, the display screen may be configured to display a video clip stored in the memory 110 and the speaker may be configured to output audio data associated with the video clip. As described, the I/O devices 114 may further include devices configured to receive input data and to transmit output data. For example, the I/O devices 114 could include a wireless network card, a transceiver, a universal serial bus (USB) port, a firewire port, a serial port, an Ethernet port, or a phone jack, among others. In one embodiment, the I/O devices 114 may be used to establish the data connection 122 with the computing device 130.

As further shown, the computing device 130 includes I/O devices 132, a CPU 134, and a memory 136. The I/O devices 132 include input devices configured to capture and/or receive data and output devices configured to output and/or transmit data. In various embodiments, the I/O devices 132 may include one or more devices that are substantially similar to the devices included in the digital camera 110. In addition, the I/O devices 132 may also include a keyboard, a monitor, and/or a mouse, among others. In one embodiment, the I/O devices 132 included in the computing device 130 are coupled to the I/O devices 114 included in the digital camera 110 via the data connection 122. For example, in embodiments where the data connection 122 is a USB data connection, the I/O devices 132 include a first USB port, the I/O devices 114 include a second USB port, and the first USB port is coupled to the second USB port via a USB cable. Data is then transferred between the computing device 130 and the digital camera 110 via the USB cable. Alternatively, in embodiments where the data connection 122 is a wireless network data connection, the I/O devices 132 may include a first wireless network card, the I/O devices 114 may include a second wireless network card, and the first wireless network card may be coupled to the second wireless network card via a wireless network. Data may then be transferred between the computing device 130 and the digital camera 110 via the wireless network.

The CPU 134 is coupled to the I/O devices 132 and to the memory 136. The CPU 134 is the primary processor included within the computing device 130. The CPU 134 may be a single-core processor, a multi-core processor, an application-specific integrated circuit (ASIC), a field-programmable gate array (FPGA), a graphics processing unit (GPU), or a combination of processing units, among others. The CPU 134 is configured to execute program instructions stored in the memory 136. The program instructions may include software applications, drivers, and/or operating systems.

The memory 136 may be a RAM unit, a DRAM unit, a flash memory module, a hard drive, or any other type of memory unit. The memory 136 includes a client application 138, operation information 140, and an A/V library 142. In one embodiment, the client application 138 is a software program configured to communicate with the digital camera 110 via the data connection 122. In some embodiments, the client application 138 is initially stored in the memory 116 on the digital camera 110 and is transferred to the memory 136 via the data connection 122. In further embodiments, the client application 138 is downloaded from the Internet to the computing device 130 via the I/O devices 132, or from another location other than the memory 116, such as a cellular network.

The client application 138 may be configured to generate and/or modify the operation information 140 and/or the A/V library 142. The A/V library 142 includes A/V data that may be received from the digital camera 110, such as the A/V data 120 or, alternatively, other A/V data received from another computing device, from the I/O devices 132, downloaded from the Internet, or downloaded from another location other than the memory 116, such as a cellular network, among others. Accordingly, the A/V library 142 may include video, audio, and or still images. In some embodiments, the A/V library 142 also includes information that specifies the storage location of the A/V data 120 within the memory 116. For example, the A/V library could include a particular memory address in the memory 116 where a particular video clip included in the A/V data 120 is stored in the memory 116 included in the digital camera 110. The A/V library 142 may further include a directory within which A/V data is organized. In one embodiment, the directory includes one or more folders that include data files, such as, for example, video clips and/or still images. Each data file may be included in a specific folder based on the date that the data file was created.

The operation information 140 is information that specifies one or more processing operations to be performed involving the A/V data 120. In one embodiment, the CPU 112 included in the digital camera 110 executes the software application 118 to perform at least one of the one or more processing operations specified in the operation information 140. In another embodiment, the operation information 140 may comprise executable code that may be executed by the CPU 112 to perform the processing operation. When the CPU 112 performs at least one of the processing operations associated with the operation data 140 and involving the A/V data 120, the CPU 134 within the computing device 130 may also perform one or more processing operations involving the A/V data 120. As described in greater detail below in FIGS. 2A-2B, the client application 138 may generate the operation information 140 based on the available processor resources and/or memory resources associated with the digital camera 110.

FIG. 2A is a conceptual diagram that illustrates the digital camera 110 and the computing device 130 of FIG. 1 in greater detail, according to one embodiment of the invention. As shown, the memory 116 within the digital camera 110 further includes metadata 202, processed A/V data 204, and the operation information 140.

In one embodiment, when the digital camera 110 is coupled to the computing device 130 and the data connection 122 is established, the digital camera 110 is declared to the computing device 130 as a mass storage device. The CPU 134 may then execute the client application 138 to access the memory 116 included in the digital camera 110 and transfer data to and/or receive data from the memory 116.

In some embodiments, the client application 138 automatically launches when the digital camera 110 is coupled to the computing device 130 and the data connection 122 is established. The client application 138 then detects whether any A/V data 120 and/or other files are stored in the memory 116 included in the digital camera 110. If A/V data 120 and/or other files are detected, then the client application 138 may locate one or more digital videos associated with the A/V data 120 and/or other files. The client application may read one or more frames from each digital video, generate a thumbnail image representing the digital video, and store the thumbnail image generated for each digital video in the A/V library 142. In another embodiment, the client application 138 may transfer some or all of the digital videos to the A/V library 142.

When the digital camera 110 is coupled to the computing device 130 via the data connection 122, the client application 138 determines the processing and/or memory resources associated with the digital camera 110. For example, the software application 138 could detect a make and/or model of the CPU 112 and/or determine an amount of unused memory resources in the memory 116. Based on the available processing and/or memory resources, the client application 138 generates operation information 140, as described in FIG. 1.

As also described in FIG. 1, the operation information 140 specifies one or more processing operations involving the A/V data 120 that can be performed by the CPU 112. A processing operation could be, for example, a transcoding operation, a frame size modification operation, a frame rate modification operation, a bit rate modification operation, a compression operation, a decompression operation, a resolution modification operation, a stitching operation, a scaling operation, a filtering operation, an image cleanup operation, a video stabilization operation, or a formatting operation, among others, that may be performed by the CPU 112 involving the A/V data 120. In one embodiment, the operation information 140 may specify several different processing operations involving the A/V data 120. In another embodiment, the operation information 140 may specify a formatting operation that converts the A/V data 120 to a platform-specific format.

The operation information 140 also specifies parameters associated with the processing operation. For example, if the processing operation is a frame size modification operation, then the operation information 140 could include a target frame size. In another example, if the processing operation is a formatting operation, then the operation information 140 could include a target format.

The client application 138 transmits the operation information 140 to the digital camera 110 via the data connection 122. In one embodiment, the memory 116 includes a communication directory, and the client application 138 transmits the operation information 140 to the communication directory. In another embodiment, the digital camera 110 is declared to the computing device 130 as a separate device, in addition to being declared to the computing device 130 as a mass storage device. The separate device includes a dedicated communication pipeline, and the client application transmits the operation information 140 to the memory 116 via the dedicated communication pipeline. In other embodiments, the client application 138 transmits the A/V data 120 to the memory 116, in addition to transmitting the operation information 140 to the memory 116.

Upon transmitting the operation information 140 to the memory 116, the client application 138 may notify the CPU 112 that the operation information 140 has been transmitted to the memory 116. The CPU 112 may then access the operation information 140 and the A/V data 120 and perform the processing operation specified by the operation information 140 involving the A/V data 120. In embodiments where the operation information 140 comprises executable code, the CPU 112 may execute the operation information 140 to perform the processing operation.

Referring again to FIG. 2A, by performing the processing operation specified in the operation information 140, the CPU 112 generates the processed A/V data 204. In one embodiment, the CPU 112 generates the processed A/V data 204 and then transmits the processed A/V data 204 to the memory 136 included in the computing device 130 for storage in the A/V library 142. In another embodiment, the CPU 112 may generate a portion of the processed A/V data 204 and then transmit the portion of the processed A/V data 204 to the memory 136. In yet another embodiment, the CPU 112 may generate the processed A/V data 204 and stream the processed A/V data 204 to the memory 136. In further embodiments, the CPU 112 may generate the processed A/V data 204 and then store the processed A/V data 204 in the memory 116 of the digital camera 110 for playback on the digital camera 110.

In one embodiment, the CPU 112 performs a first processing operation on a first portion of a video clip included in the A/V data 120 to generate a first portion of processed A/V data. The CPU 134 included in the computing device 130 simultaneously performs a second processing operation on a second portion of the video clip to generate a second portion of processed A/V data. The first and second portions of processed A/V data are then combined to generate the processed A/V data 204. In this fashion, the CPU 112 and the CPU 134 may be configured to operate in conjunction to generate the processed A/V data 204. In further embodiments, the first and second portions may be associated with a same frame of the A/V data or with different frames of the A/V data.

In another embodiment, the CPU 112 may perform a first processing operation on a first portion of the A/V data 120 to generate a first portion of processed A/V data. Simultaneously, the CPU 134 may perform the first processing operation on a second portion of the A/V data 120 to generate a second portion of processed A/V data 204. The first and second portions may then be combined to generate the processed A/V data 120.

In addition to generating the processed A/V data 204 based on the operation information 140, the CPU 112 also generates the metadata 202 based on the operation information 140. The metadata 202 includes parameters associated with the processing operation. For example, the metadata could include a frame size, frame rate, bit rate, compression status, format type, encoding protocol, and/or resolution of the processed A/V data 204, among other things. In one embodiment, the parameters included in the metadata 202 are based on the operation information 140. In some embodiments, when the CPU 112 finishes performing the processing operation, the CPU 112 causes the metadata 202 to be included in the processed A/V data 204.

When performing the processing operation, the CPU 112 causes the metadata 202 to be updated to indicate the status of the processing operation. For example, the processing operation could include a resolution modification operation, where the CPU 112 sequentially modifies the resolution of each frame of a video clip included in the A/V data 120. While performing this processing operation, the CPU 112 may cause the metadata 202 to be updated to indicate which frame is currently being processed. In this fashion, the metadata 202 may record the progress of the processing operation. Under certain circumstances, the CPU 112 may stop performing the processing operation before the processing operation is complete. In such a scenario, the CPU 112 may resume the processing operation at the appropriate frame based on the metadata 202.

In one embodiment, the CPU 112 is configured to stop the processing operation when the data connection 122 is interrupted. The digital camera 110 may receive power from then computing device 130 via the data connection 122. When the digital camera 110 is not coupled to the computing device 130, the digital camera 110 may receive power from batteries included in the digital camera 110. When the data connection 122 is interrupted, the digital camera 110 can no longer receive power from the computing device 130 via the data connection 122. The digital camera 110 may stop the processing operation to conserve battery power. In a further embodiment, the CPU 112 stops the processing operation when the data connection 122 has been interrupted for a particular pre-defined amount of time. The pre-defined amount of time may be specified by a timeout value included in the operation information 140.

Once the data connection is re-established, the CPU 112 is capable of resuming the processing operation. To resume the processing operation, the software application 118 accesses the metadata 202 and continues to process the A/V data 120.

Once the CPU 112 completes the processing operation, thereby generating the processed A/V data 204, the CPU 112 may notify the client application 138 that the processed A/V data 204 is available. In embodiments where the memory 116 includes a communication directory, the CPU 112 generates a notification indicating that the processed A/V data 204 is available. The CPU 112 stores the notification in the communication directory, along with data indicating the location of the processed A/V data 204 in the memory 116. The client application 138 polls the communication directory periodically and, when the notification is detected, the client application 138 causes the processed A/V data 204 to be transmitted to the memory 136. The CPU 112 may also store the processed A/V data 204 in the communication directory when the processing operation is complete.

In embodiments where a separate communication pipeline is implemented, the CPU 112 may transmit a message to the client application 138 indicating that the processed A/V data 204 is available once the processing operation is complete. The CPU 112 may also transmit information specifying the location of the processed A/V data 204 in the memory 116. In a further embodiment, the CPU 112 may transmit the processed A/V data 204 to the memory 136 once the processing operation is complete.

When the processed A/V data 204 is transmitted to the memory 136, the client application 138 may store the processed A/V data 204 in the A/V library 142. The client application 138 may also transmit the processed A/V data 204 to an external location, such as another computing device or the Internet. For example, the client application 138 could transmit the processed A/V data 204 to a video hosting website.

Upon completing the processing operation, the CPU 112 may also store the processed A/V data 204 in the memory 116. The CPU 112 may then cause a video portion of the processed A/V data 204 to be displayed on a display screen and/or cause an audio portion of the processed A/V data 204 to be output via a speaker. In this fashion, the digital camera 110 can be used to generate processed A/V data 204 that is accessible via the digital camera 110.

FIG. 2B is a conceptual diagram that illustrates a digital camera 210, according to one embodiment of the invention. The digital camera 210 may include some of the same components as the digital camera 110 shown in FIG. 2A. As shown, the digital camera 210 further includes an auxiliary processor 212. The auxiliary processor 212 is configured to operate in conjunction with the CPU 112 to generate the processed A/V data 204.

In one embodiment, the auxiliary processor 212 comprises dedicated hardware configured to perform specific processing operations involving the A/V data 120. For example, the auxiliary processor 212 could be configured to perform compression and/or decompression operations or encoding and/or decoding operations with the A/V data 120. When the operation information 140 specifies one or more of the specific processing operations that may be performed by the auxiliary processor 212, the CPU 112 may cause the auxiliary processor 212 to perform those specific processing operations to generate at least a portion of the processed A/V data 204. The CPU 112 may also perform some of the processing operations specified in the operation information 140 in conjunction with the processing operations performed by the auxiliary processor 212 by executing the software application 118 to generate another portion of the processed A/V data 204. Additionally, the CPU 134 within the computing device 130 may perform one or more processing operations involving the A/V data 120

In another embodiment, when the operation information 140 comprises executable code, the auxiliary processor 212 may be configured to execute the executable code to perform the one or more processing operations involving the A/V data 120. For example, the CPU 112 could identify a portion of the executable code that may be executed by the auxiliary processor 212. The auxiliary processor 212 could then execute the portion of the executable code to perform the one or more processing operations involving the A/V data 120, thereby generating at least a portion of the processed A/V data 204. The CPU 112 could execute another portion of the executable code to generate another portion of the processed A/V data 204.

In further embodiments, the auxiliary processor 212 and/or the CPU 112 may perform one or more processing operations involving the A/V data 120 in conjunction with the CPU 134 within the computing device 130 performing one or more processing operations involving the A/V data 120.

Persons skilled in the art will understand that the CPU 112, the auxiliary processor 212, and the CPU 134 may operate synchronously, asynchronously, sequentially, or in parallel to perform any of the processing operations or portions of processing operations associated with the operation information 140. Additionally, the auxiliary processor 212 may perform some, all, or none of the processing operations associated with the operation information 140. In this fashion, the auxiliary processor 212 may act as a co-processor to the CPU 112 and/or the CPU 134 to generate the processed A/V data 204.

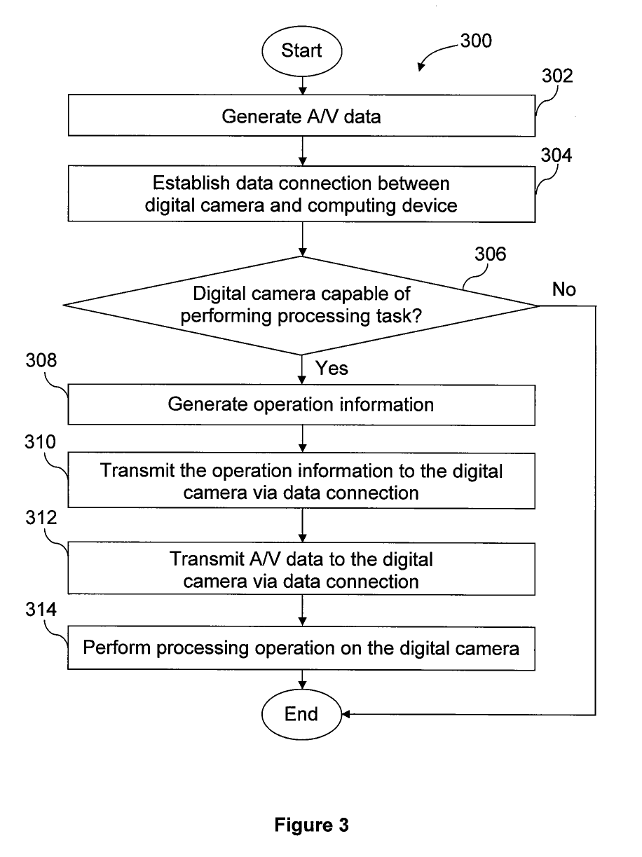

FIG. 3 is a flowchart of method steps for causing a processor residing within a digital camera to perform at least one processing operation on audio/video data stored within the digital camera, according to one embodiment of the invention. Persons skilled in the art will understand that, although the method 300 is described in conjunction with the systems of FIGS. 1-2B, any system configured to perform the method steps, in any order, is within the scope of the invention.

As shown, the method 300 begins at step 302, where the digital camera 110 generates the A/V data 120. The A/V data 120 may include digital video, audio, and/or still image data, and may be stored in the memory 116. In one embodiment, a digital camera other than the digital camera 110 generates the A/V data 120, or a computing device, such as, for example, the computing device 130, generates the A/V data 120.

At step 304, the client application 138 establishes the data connection 122 between the digital camera 110 and the computing device 130. The data connection 122 may be any type of data connection that allows data to be transferred between the digital camera 110 and the computing device 130. For example, the data connection 122 could be USB data connection or, alternatively, the data connection 122 could be a wireless network connection. When the data connection 122 is established, the client application 138 on the computing device 130 may establish communication with the software application 118 on the digital camera 110.

At step 306, the client application 138 determines whether the digital video camera 110 is capable of performing a processing task involving the A/V data 120. The client application 138 may determine whether the digital camera 110 has sufficient processing resources and/or memory resources to perform the processing task. If the digital camera 110 is capable of performing the processing task, then the method 300 proceeds to step 308. If the digital camera 110 is not capable of performing the processing operation, then the method 300 terminates.

At step 308, the client application 138 generates the operation information 140. The operation information specifies a processing operation or comprises executable code that can be executed to perform one or more processing operations. The operation information 140 may further specify one or more parameters associated with the processing operation, such as, for example, a target bit rate or a target format.

At step 310, the client application 138 transmits the operation information 140 to the software application 118 via the data connection 122. In embodiments where a communication directory in the memory 116 is implemented, the client application 138 transmits the operation information 140 to the communication directory. In embodiments where a communication pipeline is implemented, the client application 138 transmits the operation information 140 to the memory 116 included in the digital camera 110 via the communication pipeline.

At step 312, the client application 138 transmits the A/V data 120 to the digital camera 110 via the data connection 122. In embodiments where the digital camera 110 is used to capture the A/V data 120, the A/V data 120 may already be stored in the memory 116 on the digital camera 110. Thus, in these embodiments, step 312 is omitted from the method 300, and the method 300 proceeds directly from step 310 to step 314.

At step 314, a processor included in the digital camera 110 performs the processing operation specified in the operation information 140 with the A/V data 120 to generate the processed A/V data 204. The processor may be the CPU 112 and/or the auxiliary processor 212. The processor may also generate the metadata 202 associated with the processing operation. By performing the processing operation, the processor may cause the A/V data 120 to be converted into a different format, converted to a different bit rate, converted to different resolution, scaled to a different frame size, transcoded, compressed, or decompressed, among others. In one embodiment, the processor executes the software application 118 to perform the processing operation. In another embodiment, the processor may execute the operation information 140 to perform the processing operation. In yet another embodiment, the CPU 112 and/or the auxiliary processor 210 may perform a first processing operation involving the A/V data 120 and, simultaneously, the CPU 134 within the computing device 130 may perform the first or a second processing operation involving the A/V data 120.

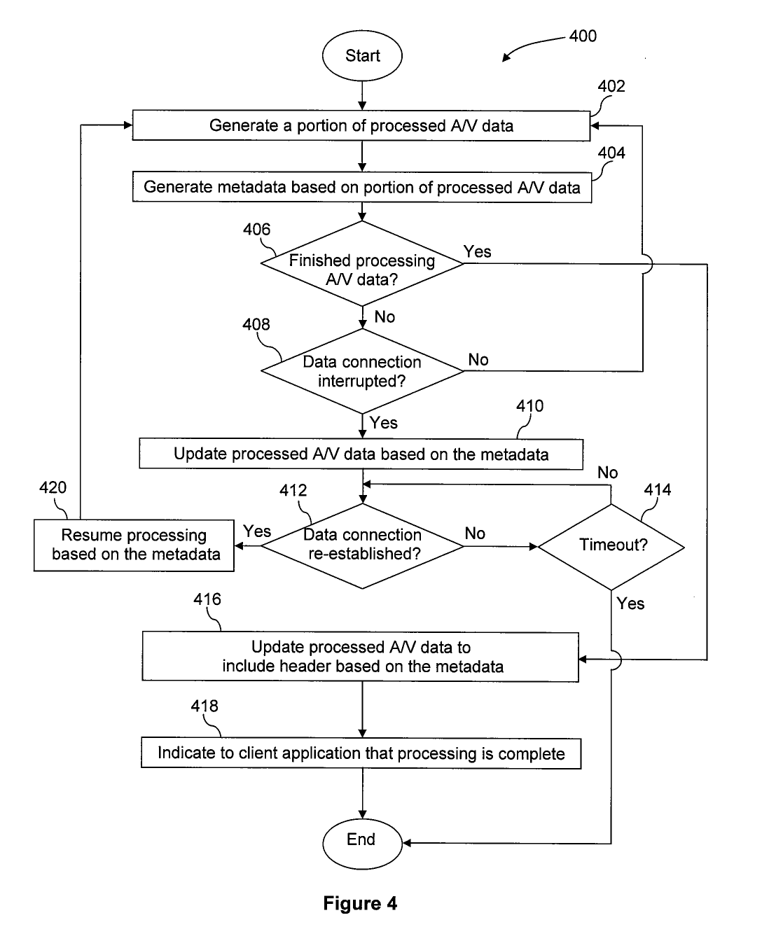

As described in greater detail below in FIG. 4, in embodiments where the processor generates the metadata 202, the processor generates the metadata 202 so that, in a circumstance where the data connection 122 is interrupted and/or the processor stops performing the processing operation, the processor may resume the processing operation at or around the frame/location at which the processing operation stopped.

FIG. 4 is a flowchart of method steps for causing a processor residing within a digital camera to generate processed audio/video data either separately or in conjunction with a processor residing within a computing device, according to one embodiment of the invention. Persons skilled in the art will understand that, although the method 400 is described in conjunction with the systems of FIGS. 1-2B, any system configured to perform the method steps, in any order, is within the scope of the present invention.

As shown, the method 400 begins at step 402, where the processor generates a portion of processed A/V data. For example, the processor may transcode ten (10) frames of a video clip included in the A/V data 120, where the video clip includes one hundred (100) frames. In one embodiment, the processor comprises the CPU 112. In another embodiment, the processor may comprise the auxiliary processor 212. In yet another embodiment, the CPU 134 within the computing device 130 may operate in conjunction with the processor to generate a portion of A/V data by performing a processing operation involving the A/V data 120.

At step 404, the processor generates the metadata 202 based on the portion of processed A/V data generated at step 402. In one embodiment, pre-existing metadata refreshed with updated metadata 202. The metadata 202 includes information associated with the processing operation being performed by the processor, such as the frame size, frame rate, bit rate, compression status, format type, encoding protocol, and resolution, among other things. The metadata 202 also indicates the status of the processing operation being performed by the processor. For example, the metadata 202 could specify a frame of a video clip currently being transcoded.

At step 406, the processor determines whether the processing operation is complete. If the processor determines that the processing operation is complete, then the method 400 proceeds to step 416.

At step 416, the processor updates the processed A/V data to include a header that is based on the metadata 202. The header may specify formatting information, bit rate information, frame size information, frame rate information, or compression status, among other things.

At step 418, the processor indicates to the client application 138 that the processing operation is complete. In embodiments where the communication directory is implemented to communicate with the client application 138, the processor generates a notification and stores the notification in the communication directory. The processor may also store data indicating the location of the processed A/V data 204 in the memory 116. In embodiments where a communication pipeline is implemented, the processor transmits a message to the client application 138 indicating that the processing operation is complete, along with information specifying the location of the processed A/V data 204 in the memory 116.

Referring now back to step 406, if the processor determines that the processing operation is not complete, then the method 400 proceeds to step 408. At step 408, the processor determines whether the data connection 122 is interrupted. In embodiments where the data connection 122 is a USB data connection comprising a USB cable, the data connection 122 may be interrupted when, for example, the USB cable is unplugged from either the digital camera 110 or from the computing device 130. In embodiments where the data connection is a wireless network data connection, the data connection 122 may be interrupted when, for example, reliable communication over the wireless network data connection cannot be maintained. Those skilled in the art will understand that the data connection 122 may be interrupted in a variety of ways depending on the implementation of the data connection 122, among other things. If the processor determines that the data connection 122 is not interrupted, then the method 400 returns to step 402. If the processor determines that the data connection 122 is interrupted, then the method 400 proceeds to step 410.

At step 410, the processor updates the processed A/V data based on the metadata 202. As described, the metadata 202 specifies, among other things, the progress of the processing operation being performed by the processor.

At step 412, the processor determines whether the data connection 122 is re-established. If the processor determines that the data connection 122 is not re-established, then the method 400 proceeds to step 414.

At step 414, the processor determines whether a timeout value has elapsed. The timeout value specifies an amount of time that the data connection 122 can be interrupted and the processing operation can be resumed. In one embodiment, the timeout value is included in the operation information 140. At step 414, if the processor determines that the timeout value has not elapsed, then the method 400 returns to step 412. If the processor determines that the timeout value has elapsed, then the method 400 terminates.

Referring again to step 412, if the processor determines that the data connection 122 has been re-established, then the method 400 proceeds to step 420. At step 420, the processor resumes the processing operation based on the metadata 202. The method 400 then proceeds to step 402 and proceeds as described above. The metadata specifies a most recently processed frame/location in the A/V data 120 in order to track the progress of the processing operation. The metadata may thus be used to resume processing the A/V data 120 at the frame/location specified in the metadata 202.

In sum, a processor in a digital camera that is in data communication with a computing device is configured to act as a co-processor in conjunction with a processor included in the computing device to perform one or more processing operations involving audio/video (A/V) data. When the processor in the digital camera performs the one or more processing operations involving the A/V data, a processor within the computing device may simultaneously perform one or more processing operations involving the A/V data.

The A/V data may include digital video, audio, and/or still images. The one or more processing operations may include encoding operations, decoding operations, transcoding operations, frame scaling operations, compression operations, decompression operations, frame sizing operations, bit rate modification operations, frame rate modification operations, resolution modification operations, stitching operations, or other processing operations that involve A/V data.

The processor in the computing device executes a client application to locate the A/V data and to determine whether the processor in the digital camera is capable of performing one or more processing operations involving the A/V data. If the processor in the digital camera is capable of performing at least one of the one or more processing operations, then the processor in the computing device generates “operation information.” The operation information specifies at least one processing operation to be performed and different parameters associated with the processing operation. The operation information may comprise executable code. The processor in the computing device causes the operation information to be transmitted to the digital camera. The processor in the digital camera then performs the processing operation specified by the operation information to generate processed A/V data. The processor in the digital camera may then store the processed A/V data in memory included in the digital camera and/or transmit the processed A/V data to the computing device for storage.

Additionally, the A/V data on which the processor in the digital camera performs processing operations may be received from the computing device or captured using a different digital camera. For example, the computing device could download a digital video from the Internet and then transfer the digital video to the digital camera. The processor in the digital camera could then convert the digital video into a particular format that allows the digital video to be uploaded and played-back on a video hosting website.

Advantageously, processor resource requirements are relaxed across the system since all or part of the processing operations that would otherwise be performed by a processor in the computing device can be offloaded onto the processor in the digital camera. The end-user is, thus, not limited by the processing limitations of the computing device when performing processing operations involving the A/V data. Consequently, greater processing efficiency is achieved and portability of the A/V data is increased.

While the forgoing is directed to embodiments of the invention, other and further embodiments of the invention may be devised without departing from the basic scope thereof. For example, aspects of the invention may be implemented in hardware or software or in a combination of hardware and software. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the invention, are embodiments of the invention.

In view of the foregoing, the scope of the invention is determined by the claims that follow.

What is claimed is:

1. A computer-implemented method for performing one or more processing operations involving a digital camera in data communication with a computing device, the method comprising:
determining that audio/video data is stored in a memory included within the digital camera;
determining at least one processing operation that can be performed on the audio/video data by a processor included in the digital camera; and
causing the processor included in the digital camera to generate processed audio/video data by performing the at least one processing operation on at least a portion of the audio/video data.

2. The method of claim 1, further comprising the step of determining which processing resources are available within the digital camera, wherein the step of determining the at least one processing operation that can be performed on the audio/video data by the processor included in the digital camera is based on the processing resources available within the digital camera.

3. The method of claim 1, wherein the processor within the digital camera that performs the at least one processing operation on the at least a portion of the audio/video data to generate the processed audio/video data comprises a central processing unit (CPU) or an auxiliary processor coupled to the CPU.

4. The method of claim 3, wherein the auxiliary processor includes dedicated hardware configured to execute the at least one processing operation.

5. The method of claim 1, further comprising the step of generating metadata that specifies a current frame of the audio/video data on which the at least one processing operation is being performed.

6. The method of claim 5, further comprising the steps of:
determining that the data communication between the digital camera and the computing device has been interrupted;
causing the at least one processing operation to terminate;
storing the metadata in the memory included within the digital camera;
determining that the data communication between the digital camera and the computing device has been reestablished;
parsing the metadata stored in the memory within the digital camera to identify the current frame of the audio/video data; and
causing the at least one processing operation to resume on the audio/video data.

7. The method of claim 1, wherein the memory included within the digital camera stores a command directory, and further comprising the step of causing commands to be stored in the command directory for execution by the processor included in the digital camera when performing the at least one processing operation.

8. The method of claim 1, further comprising the steps of:
declaring the digital camera to the computing device as a first device identifiable as a mass storage device; and
declaring the digital camera to the computing device as a second device identifiable as a separate device having a dedicated communication pipeline between the digital camera and the computing device.

9. The method of claim 1, wherein the digital camera and the computing device are coupled together via a universal serial bus (USB) connection or a wireless connection.

10. The method of claim 1, further comprising the steps of:
causing the processor included in the digital camera to generate a first portion of processed audio/video data by performing a first processing operation on a first portion of the audio/video data; and
causing a processor included in the computing device to generate a second portion of processed audio/video data by performing a second processing operation on a second portion of the audio/video data.

11. The method of claim 10, wherein the first portion of the audio/video data is associated with a first frame of the audio/video data, and the second portion of the audio/video data is associated with a second frame of the audio/video data.

12. The method of claim 10, wherein the first portion of the audio/video data and the second portion of the audio/video data are both associated with a first frame of the audio/video data.

13. The method of claim 1, further comprising the steps of:
causing the processor included in the digital camera to generate a first portion of processed audio/video data by performing a first processing operation on a first portion of the audio/video data; and
causing a processor included in the computing device to generate a second portion of processed audio/video data by performing the first processing operation on a second portion of the audio/video data.

14. The method of claim 1, wherein the at least one processing operation includes a transcoding operation, a frame size modification operation, a frame rate modification operation, a bit rate modification operation, a compression operation, or a decompression operation.

15. The method of claim 1, wherein the at least one processing operation includes a resolution modification operation, a stitching operation, a scaling operation, a filtering operation, an image cleanup operation, or a video stabilization operation, or a formatting operation.

16. A computer-readable medium storing program instructions that, when executed by a processor, cause one or more processing operations to be performed involving a digital camera in data communication with a computing device by performing the steps of:
determining that audio/video data is stored in a memory included within the digital camera;
determining at least one processing operation that can be performed on the audio/video data by a processor included in the digital camera; and
causing the processor included in the digital camera to generate processed audio/video data by performing the at least one processing operation on at least a portion of the audio/video data.

17. The computer-readable medium of claim 16, further comprising the step of determining which processing resources are available within the digital camera, wherein the step of determining the at least one processing operation that can be performed on the audio/video data by the processor included in the digital camera is based on the processing resources available within the digital camera.

18. The computer-readable medium of claim 16, further comprising the step of generating metadata that specifies a current frame of the audio/video data on which the at least one processing operation is being performed.

19. The computer-readable medium of claim 18, further comprising the steps of:
determining that the data communication between the digital camera and the computing device has been interrupted;
causing the at least one processing operation to terminate;
storing the metadata in the memory included within the digital camera;
determining that the data communication between the digital camera and the computing device has been reestablished;
parsing the metadata stored in the memory within the digital camera to identify the current frame of the audio/video data; and
causing the at least one processing operation to resume on the audio/video data.

20. A system for performing one or more processing operations involving a digital camera in data communication with a computing device, comprising:
a central processing unit;
one or more input/output devices configured to be coupled to a digital camera; and
a memory unit, wherein the memory unit includes a client application configured to:
determine that audio/video data is stored in a memory included within the digital camera,
determine at least one processing operation that can be performed on the audio/video data by a processor included in the digital camera, and
cause the processor included in the digital camera to generate processed audio/video data by performing the at least one processing operation on at least a portion of the audio/video data.
